(19) United States
(12) Patent Application Publication
(10) Pub. No.: US 2020/0231184 A1
(43) Pub. Date: Jul. 23, 2020

(54) METHOD AND APPARATUS FOR MEASURING USER ACCEPTANCE OF AUTONOMOUS VEHICLE, AND ELECTRONIC DEVICE

(71) Applicant: BEIJING BAIDU NETCOM SCIENCE AND TECHNOLOGY CO., LTD., Beijing (CN)

(72) Inventors: Ya WANG, Beijing (CN); Xiaojun LUO, Beijing (CN); Qiuyu ZHANG, Beijing (CN); Yingzhu QIAN, Beijing (CN); Qihao HUANG, Beijing (CN); Liping LI, Beijing (CN)

(21) Appl. No.: 16/748,504

(22) Filed: Jan. 21, 2020

(30) Foreign Application Priority Data
Jan. 22, 2019 (CN) 201910057883.2

(51) Int. Cl. B60W 60/00; G05D 1/00; B60W 50/08

(52) U.S. Cl. CPC B60W 60/0059; G05D 1/0061; B60W 60/0053; B60W 60/0057; B60W 50/082

(57) ABSTRACT

The present disclosure provides a method for measuring user acceptance of an autonomous vehicle, an apparatus, an electronic device and a storage medium and relates to a technical field of information processing. The method includes: determining a feature for each of a plurality of functional dimensions of a vehicle to be tested according to configuration information of the vehicle to be tested; determining a current acceptance value for each of a plurality of acceptance dimensions corresponding to the vehicle to be tested, according to a preset mapping relationship between the functional dimension and the acceptance dimension as well as the feature for the functional dimension of the vehicle to be tested; and determining the user acceptance of the vehicle to be tested according to the current acceptance values for the plurality of the acceptance dimensions.

### CROSS REFERENCE TO RELATED APPLICATION

This application claims priority to Chinese Patent Application No. 201910057883.2, filed with the State Intellectual Property Office of P. R. China on Jan. 22, 2019, the entire contents of which are incorporated herein by reference.

### TECHNICAL FIELD

The present disclosure relates to the technical field of information processing, and more particularly, to a method and an apparatus for measuring user acceptance of an autonomous vehicle, an electronic device and a storage medium.

### BACKGROUND

With the continued development in automation, robotics and artificial intelligence, vehicles with autonomous driving capabilities have begun to enter into people's daily life. An autonomous vehicle senses the surrounding environment of the vehicle with an in-vehicle sensor, and controls the steering and speed of the vehicle according to information of, for example, the road, the vehicle position, and the obstacle obtained from sensing, so that the vehicle can move safely and reliably on the road.

The US Department of Transportation has issued the Federal Automated Vehicles Policy. China has also introduced the intelligent connected vehicle as a focus of innovation development in the Five-Year Blueprint for Intelligent Manufacturing (2016-2020) issued by the Ministry of Industry and Information Technology and the Ministry of Finance. Other major countries in the world have also provided a lot of support for this course.

Despite all the technological advances and government support, the general public still hesitate to allow fully autonomous vehicles on the road. Whether the public would truly accept autonomous vehicles is a key factor in the application of autonomous driving technology. The instant disclosure provides technology for accurately measuring the user acceptance of autonomous vehicles, thereby providing guidance and support for the development and operation of autonomous vehicles.

### SUMMARY

A method for measuring user acceptance of an autonomous vehicle, an apparatus, an electronic device and a storage medium according to the present disclosure are used to solve a problem in the art that the development and operation of the autonomous vehicles could not be guided and supported since the user acceptance of the autonomous vehicles cannot be measured accurately in the prior art.

A method for measuring user acceptance of an autonomous vehicle according to embodiments of a first aspect of the present disclosure includes: determining a feature for each of a plurality of functional dimensions of a vehicle to be tested according to configuration information of the vehicle to be tested; determining a current acceptance value for each of a plurality of acceptance dimensions corresponding to the vehicle to be tested, according to a preset mapping relationship between the functional dimension and the acceptance dimension as well as the feature for the functional dimension of the vehicle to be tested; and determining the user acceptance of the vehicle to be tested according to the current acceptance values for the plurality of the acceptance dimensions.

An apparatus for measuring user acceptance of an autonomous vehicle according to embodiments of another aspect of the present disclosure includes: a first determination module, configured to determine a feature for each of a plurality of functional dimensions of a vehicle to be tested according to configuration information of the vehicle to be tested; a second determination module, configured to a current acceptance value for each of a plurality of acceptance dimensions corresponding to the vehicle to be tested, according to a preset mapping relationship between the functional dimension and the acceptance dimension as well as the feature for the functional dimension of the vehicle to be tested; and a third determination module, configured to determine the user acceptance of the vehicle to be tested according to the current acceptance values for the plurality of the acceptance dimensions.

An electronic device according to embodiments of yet another aspect of the present disclosure includes: a memory, a processor and a program stored in the memory and executable on the processor, wherein, when the processor executes the program, the processor implements the method for measuring the user acceptance of the autonomous vehicle as described above.

A computer readable storage medium according to embodiments of still yet another aspect of the present disclosure has a computer program stored thereon, wherein when the program is executed by a processor, the program implements the method for measuring the user acceptance of the autonomous vehicle as described above.

A computer program according to embodiments of still yet another aspect of the present disclosure is configured to implement the method for measuring the user acceptance of the autonomous vehicle according to the embodiments of the present disclosure when the program is executed by a processor.

The method for measuring the user acceptance of the autonomous vehicle, the apparatus, the electronic device, the computer readable storage medium and the computer program according to the embodiments of the present disclosure may determine a feature for each of a plurality of functional dimension of a vehicle to be tested according to configuration information of the vehicle to be tested; determine a current acceptance value for each of a plurality of acceptance dimensions corresponding to the vehicle to be tested, according to a preset mapping relationship between the functional dimension and the acceptance dimension as well as the feature for the functional dimension of the vehicle to be tested; and determine the user acceptance of the vehicle to be tested according to the current acceptance values for the plurality of the acceptance dimensions. Consequently, by determining the user acceptance of the vehicle to be tested according to the configuration information of the vehicle to be tested and the preset mapping relationship between each functional dimension and each acceptance dimension, the user acceptance of the autonomous vehicle may be measured accurately for guiding and supporting the development and operation of the autonomous vehicle.

Additional aspects and advantages of embodiments of present disclosure will be given in part in the following descriptions, become apparent in part from the following descriptions, or be learned from the practice of the embodiments of the present disclosure.

### BRIEF DESCRIPTION OF THE DRAWINGS

These and other aspects and advantages of embodiments of the present disclosure will become apparent and more readily appreciated from the following descriptions made with reference to the accompanying drawings.

FIG. 1 is a flow chart of a method for measuring user acceptance of an autonomous vehicle according to an embodiment of the present disclosure.

FIG. 2-1 is a schematic diagram of a mapping relationship between three acceptance dimensions: controllability, benefit perception and popularization anticipation, and their respective functional dimensions.

FIG. 2-2 is a schematic diagram of features for the functional dimensions of a vehicle to be tested corresponding to each acceptance dimension.

FIG. 2-3 is a schematic diagram of a structural equation model between each acceptance dimension and cognitive safety and emotional safety.

FIG. 2-4 is a schematic diagram of a structural equation model between acceptance and each acceptance dimension.

FIG. 3 is a flow chart of a method for measuring user acceptance of an autonomous vehicle according to another embodiment of the present disclosure.

FIG. 4 is a schematic diagram of the importance and distributions of dependent resources of each acceptance dimension.

FIG. 5 is a schematic structure diagram of an apparatus for measuring user acceptance of an autonomous vehicle according to an embodiment of the present disclosure.

FIG. 6 is a schematic structure diagram of an electronic device according to an embodiment of the present disclosure.

### DETAILED DESCRIPTION

Embodiments of the present disclosure will be described below in detail, examples of which are illustrated in accompanying drawings. Throughout the drawings, the same or similar reference signs refer to the same or similar elements or elements that have the same or similar functions. The embodiments described below with reference to the accompanying drawings are merely exemplary and intends to illustrate and explain the present disclosure, and should not be construed as a limit to the present disclosure.

With respect to a problem in the art that as the user acceptance of autonomous vehicles cannot be accurately measured, guidance and support cannot be provided for the development and operation of autonomous vehicles, embodiments of the present disclosure provide a method for measuring user acceptance of an autonomous vehicle.

The method for measuring the user acceptance of the autonomous vehicle according to the embodiments of the present disclosure may determine a feature for each of a plurality of functional dimensions of a vehicle to be tested according to configuration information of the vehicle to be tested; determine a current acceptance value for each of a plurality of acceptance dimensions corresponding to the vehicle to be tested, according to a preset mapping relationship between the functional dimension and the acceptance dimension as well as the feature for the functional dimension of the vehicle to be tested; and determine the user acceptance of the vehicle to be tested according to the current acceptance values for the plurality of the acceptance dimensions. In this way, by determining the user acceptance of the vehicle to be tested according to the configuration information of the vehicle to be tested and the preset mapping relationship between the feature for each of the plurality of preset functional dimensions and each of the plurality of acceptance dimensions, the user acceptance of the autonomous vehicle may be measured accurately for guiding and supporting development and operation of the autonomous vehicles.

The method and apparatus for measuring user acceptance of an autonomous vehicle, the electronic device, the storage medium and the computer program according to the present disclosure will be described in detail with reference to the drawings.

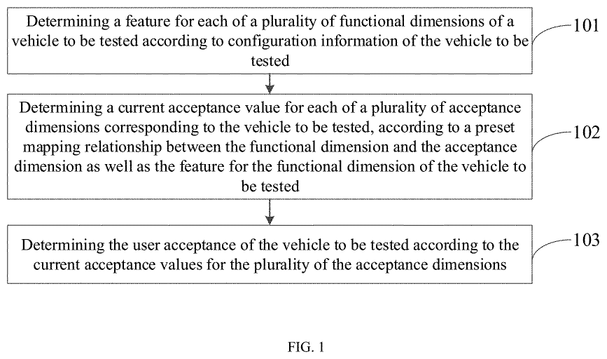

FIG. 1 is a flow chart of a method for measuring user acceptance of an autonomous vehicle according to an embodiment of the present disclosure.

As shown in FIG. 1, the method for measuring the user acceptance of an autonomous vehicle includes the following steps.

In step 101, a feature for each of a plurality of functional dimensions of a vehicle to be tested is determined according to configuration information of the vehicle to be tested.

Functional dimensions refer to specific affecting factors that may influence the user acceptance of the autonomous vehicle, which may be determined by means of early-stage literature analyses, expert interviews, user interviews, open-ended questionnaire investigations and the like. In an embodiment, the functional dimensions may include 37 dimensions as shown in table 1.

TABLE 1

| | |
|---|---|
| 1. Possibility of an accident | 20. Seat comfort |
| 2. Severity of an accident | 21. Collision avoidance |
| | characteristics of the vehicle |
| | body and the seat |
| 3. Possibility of a fault | 22. Is it possible to interact with |
| | pedestrians and other vehicles |
| | sufficiently |
| 4. Severity of a fault | 23. Driving speed |
| 5. Is it easy to troubleshoot | 24. Is there a human |
| | driver responsible for |
| | safety during driving |
| 6. Driving comfort | 25. Weather conditions |
| | during driving, such as dark |
| | night, rain, snow, fog, etc. |
| 7. Is it possible for a user to intervene | 26. Total number of people using |
| the autonomous vehicle at any time | the autonomous vehicle at present |
| 8. System capability for | 27. Media coverage and evaluation |
| understanding and adapting to | of the autonomous vehicle |
| complex traffic environments | |
| 9. Is it easy for the | 28. Comments on the autonomous |
| user to understand behaviors | vehicle from the government |
| of the vehicle | or research institutes |
| 10. Are the feedbacks of the vehicle | 29. Are there any highly reliable |
| state and the driving state timely and | test data reports |
| sufficient | |
| 11. Protection for personal privacy | 30. Policy support or restrictions |
| | for the autonomous vehicle |
| 12. Possibility of the system being | 31. Recognition and reputation of |
| controlled by a hacker or a virus | manufacturers of the |
| | autonomous vehicle |
| 13. Is it possible to change driving | 32. Purpose of driving, such as |
| characteristics in the | to work, to travel |
| system according to my | |
| habits and intentions | |
| 14. Is it possible to adjust driving | 33. State of driver, such as fatigued, |
| habits in the system manually | irritable... |
| 15. Design for a virtual image of an | 34. Are there any other users |
| intelligent assistant | around, such as family, |
| | colleagues, neighbors, etc. |
| 16. Design for voice interaction | 35. Is it possible to brake the |
| of the intelligent assistant | vehicle reliably in emergency |
| 17. Is the interaction interface easy | 36. Are there any well-known |
| to use | individuals using the |
| | autonomous vehicle in practice |
| 18. Appearance design of the vehicle | 37. Is there an emergency-call |
| 19. Interior design of the vehicle | function |

In the embodiment of the present disclosure, a feature for a functional dimension of a vehicle to be tested refers to a specific characteristic of the vehicle to be tested in each functional dimension that is determined according to configuration information of the vehicle to be tested. For example, when a physical button for emergency braking is provided in the vehicle to be tested, the feature for the functional dimension corresponding to the functional dimension of “Is it possible to brake the vehicle reliably in an emergency?” is “yes”. Therefore, the feature for each of a plurality of functional dimension of the vehicle to be tested may be determined one by one according to the configuration information of the vehicle to be tested.

In step 102, a current acceptance value for each of a plurality of acceptance dimensions corresponding to the vehicle to be tested is determined according to a preset mapping relationship between the functional dimension and the acceptance dimension as well as the feature for the functional dimension of the vehicle to be tested.

The acceptance dimension refers to psychological affecting factors influencing the user acceptance, and may include eight dimensions, which are controllability, benefit perception, popularization anticipation, usability, level of awareness, social support, policy confidence and tendency of seeking new technology. In the embodiment of the present disclosure, the controllability indicates whether the autonomous vehicle may be well controlled or not; the benefit perception indicates whether the autonomous vehicle may make the driving process comfortable and efficient; the popularization anticipation indicates whether the user is optimistic about the traffic system and the supporting services may be quickly completed after the autonomous vehicle is put into use; the usability indicates whether the autonomous driving system is simple to operate and easy to understand; the level of awareness indicates whether the user knows about the automatic driving technology and related products; the social support indicates whether there are some important people supporting to use the autonomous vehicle; the policy confidence indicates whether the user believes that the government will make relevant policies of automatic driving in the benefit of the public; and the tendency of seeking new technology indicates the degree of seeking and acceptance of an individual to a new technology.

As a possible implementation, people's opinions on each acceptance dimension and people's evaluation of the significance of each functional dimension affecting the user acceptance of the autonomous vehicle may be obtained through a questionnaire survey.

Alternatively, the new technology tendency is used for measuring the seeking and degree of acceptance of an individual to a new technology and may be measured with 4 entries, e.g., “when I heard a new technology, I will find a way to experience it”. The policy confidence is used for measuring degree of confidence of the subject that the government will promote the development of the autonomous vehicle and may be measured with 6 entries, e.g. “I believe that our government will strongly support the development of the autonomous vehicle”. The social support is used for measuring the opinions of some important people around the subject on the autonomous vehicle and may be measured with 4 entries, e.g. “my friends think that I should drive an autonomous vehicle”. The level of awareness is used for measuring how the subject knows about the automatic driving technology and may be measured with 4 entries, such as “I've never heard of any technologies or products like this”. The usability is used for measuring the subject's opinions on whether the interaction interface of the autonomous vehicle is easy to use and may be measured with 4 entries, e.g. “I believe that the automatic driving system in the vehicle will be easy to understand”. The popularization anticipation is used for measuring the subject's opinions on whether the roads and social environments may be quickly completed during practical popularization of the autonomous vehicle, and may be measured with 5 entries, such as “I think that obstacles encountered in the popularization of the autonomous vehicle will be overcome soon”. The benefit perception is used for measuring the subject's comprehensive opinions on benefits brought by the autonomous vehicle, and may be measured with 4 entries, such as “the autonomous vehicle will help alleviate driving fatigue”. The controllability is used for measuring a sense of control of the subject over the autonomous vehicle, and may be measured with four entries, such as “if such a product is released, I am confident of driving the vehicle at ease”. During the questionnaire survey, the subject is requested to answer on a 7-point scale, with 1 indicating extremely dissatisfied and 7 indicating extremely satisfied.

When the significance of each functional dimension affecting the user acceptance of the autonomous vehicle is evaluated by means of the questionnaire survey, the subject is requested to answer on a 4-point scale, with 1 indicating no effect and 4 indicating a great effect. According to the investigation results, the functional dimensions are ranked from high to low depending on the significance of each functional dimension as the subject believed, as shown in tables 2 and 3.

In an embodiment, after a large amount of survey data about the acceptance dimensions and the significance of each functional dimension affecting the user acceptance of the autonomous vehicle are acquired, the acquired data may be analyzed through a structural equation model to determine a mapping relationship between each functional dimension and each acceptance dimension. That is, in the embodiment of the present disclosure, before the step 102, the method may further include: performing statistical analysis on data in a statistical data collection by using a structural equation model, to determine the preset mapping relationship between the functional dimension and the acceptance dimension.

The statistical data collection refers to a set of data formed by data acquired through early-stage literature analyses, expert interviews, user interviews, open-ended questionnaire investigations and the like.

The structural equation model is a kind of multivariate statistical analysis technology and is widely applied in the fields of psychology, sociology, management science and the like. Primarily, it may be used to verify whether a measurement scale matches the data. Compared with conventional analysis of reliability and validity, the structural equation model has the following advantages. First, it considers and processes multiple dependent variables simultaneously. Second it allows measurement errors in independent variables and dependent variables. Third, relationships between respective factor structures and factors may be estimated simultaneously. Fourth, a model with complex dependency relations, such as an index dependent on multiple factors or high-order factor taken into consideration, may be processed. And fifth, the fitting degree of the entire model may be estimated.

In the embodiment of the present disclosure, a correlation between each functional dimension and each acceptance dimension, i.e., the influence of each functional dimension on each acceptance dimension, may be determined by performing statistical analyses on respective data in the acquired statistical data collection through the structural equation model. And then, the functional dimension corresponding to each acceptance dimension, i.e., the functional dimension correlated to each acceptance dimension, is determined according to the correlation between each functional dimension and each acceptance dimension. Consequently, the mapping relationship between each functional dimension and each acceptance dimension is determined according to the functional dimension corresponding to each acceptance dimension.

Table 4 shows a relationship between 7 acceptance dimensions and 37 functional dimensions, in which “+” indicates a general correlation, “++” indicates a close correlation, and a blank indicates no correlation. Further, the tendency of seeking new technology is not listed in the table since it belongs to individual difference variables.

TABLE 4

| | Level of | Popularization | Policy | Social | Benefit | | |
|---|---|---|---|---|---|---|---|
| | Awareness | Anticipation | Support | Support | Perception | Usability | Controllability |
| 1. Possibility of an accident | + | + | | | ++ | | + |
| 2. Severity of an accident | + | + | | | ++ | | + |
| 3. Possibility of a fault | + | + | | | ++ | | + |
| 4. Severity of a fault | + | + | | | ++ | | + |
| 5. Is it easy to troubleshoot? | + | | | | ++ | ++ | + |
| 6. Driving comfort | | + | | | ++ | ++ | + |
| 7. Is it possible for a user to | | | | | + | + | ++ |
| intervene the autonomous | | | | | | | |
| vehicle at any time? | | | | | | | |
| 8. System capability for | | + | | | ++ | + | + |
| understanding and adapting to | | | | | | | |
| complex traffic environments | | | | | | | |
| 9. Is it easy for the user to | ++ | | | | + | ++ | + |
| understand behaviors of the | | | | | | | |
| vehicle? | | | | | | | |
| 10. Are the feedbacks of the | ++ | | | | + | ++ | + |
| vehicle state and the driving | | | | | | | |
| state timely and sufficient? | | | | | | | |
| 11. Protection for personal | + | | | | + | | + |
| privacy | | | | | | | |
| 12. Possibility of the system | | | | | + | | + |
| being controlled by a hacker | | | | | | | |
| or a virus | | | | | | | |
| 13. Is it possible to change | | | | | + | ++ | + |
| driving characteristics in the | | | | | | | |
| system according to my habits | | | | | | | |
| and intentions? | | | | | | | |
| 14. Is it possible to adjust | | | | | + | + | + |
| driving habits in the system | | | | | | | |
| manually? | | | | | | | |
| 15. Design for a virtual image | | | | | | ++ | |
| of an intelligent assistant | | | | | | | |
| 16. Design for voice | | | | | | ++ | |
| interaction of the intelligent | | | | | | | |
| assistant | | | | | | | |
| 17. Is the interaction interface | | | | | | ++ | |
| easy to use? | | | | | | | |
| 18. Appearance design of the | | | | | + | ++ | |
| vehicle | | | | | | | |
| 19. Interior design of the | | | | | + | ++ | |
| vehicle | | | | | | | |
| 20. Seat comfort | | | | | + | ++ | |
| 21. Collision avoidance | | | | | + | + | + |
| characteristics of the vehicle | | | | | | | |
| body and the seat | | | | | | | |
| 22. Is it possible to interact | | + | | + | + | ++ | |
| with pedestrians and other | | | | | | | |
| vehicles sufficiently? | | | | | | | |
| 23. Driving speed | | + | | | | | + |
| 24. Is there a human driver | | + | | | + | | ++ |
| responsible for safety during | | | | | | | |
| driving? | | | | | | | |
| 25. Weather conditions during | | + | | | | | + |
| driving, such as dark night, | | | | | | | |
| rain, snow, fog, etc. | | | | | | | |
| 26. Total number of people | ++ | ++ | | ++ | | | |
| using the autonomous vehicle | | | | | | | |
| at present | | | | | | | |
| 27. Media coverage and | ++ | + | | ++ | | | |
| evaluation of the autonomous | | | | | | | |
| vehicle | | | | | | | |
| 28. Comments on the | ++ | ++ | ++ | ++ | | | |
| autonomous vehicle from the | | | | | | | |
| government or research | | | | | | | |
| institutes | | | | | | | |
| 29. Are there any highly | ++ | | | | | | |
| reliable test data reports? | | | | | | | |
| 30. Policy support or | ++ | ++ | ++ | ++ | | | |
| restrictions for the | | | | | | | |
| autonomous vehicle | | | | | | | |
| 31. Recognition and | ++ | | | ++ | | | |
| reputation of manufacturers of | | | | | | | |
| the autonomous vehicle | | | | | | | |
| 32. Purpose of driving, such | | | | + | | | |
| as to work, to travel | | | | | | | |
| 33. State of driver, such as | | | | | | + | + |
| fatigued, irritable... | | | | | | | |
| 34. Are there any other users | | | | ++ | | | |
| around, such as family, | | | | | | | |
| colleagues, neighbors, etc.? | | | | | | | |
| 35. Is it possible to brake the | | | | | | ++ | ++ |
| vehicle reliably in | | | | | | | |
| emergency? | | | | | | | |
| 36. Are there any well-known | + | | | + | | | |
| individuals using the | | | | | | | |
| autonomous vehicle in | | | | | | | |
| practice? | | | | | | | |
| 37. Is there an emergency-call | | | | | | ++ | ++ |
| function? | | | | | | | |

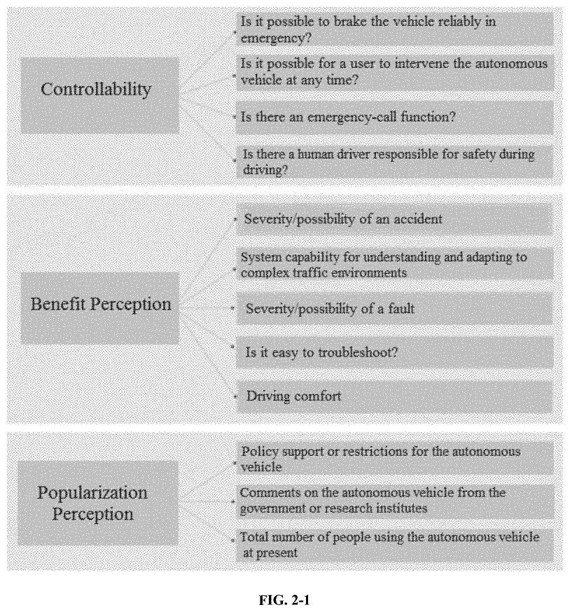

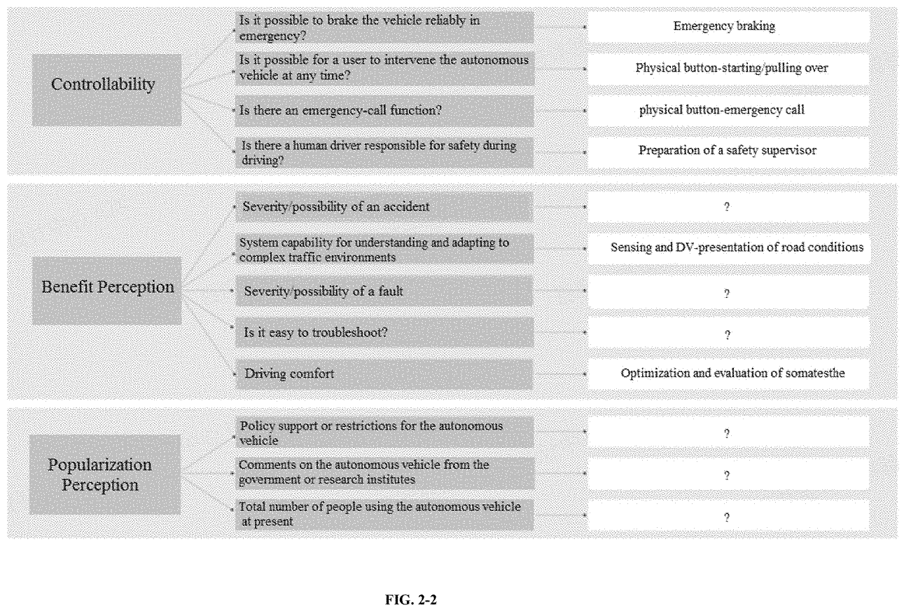

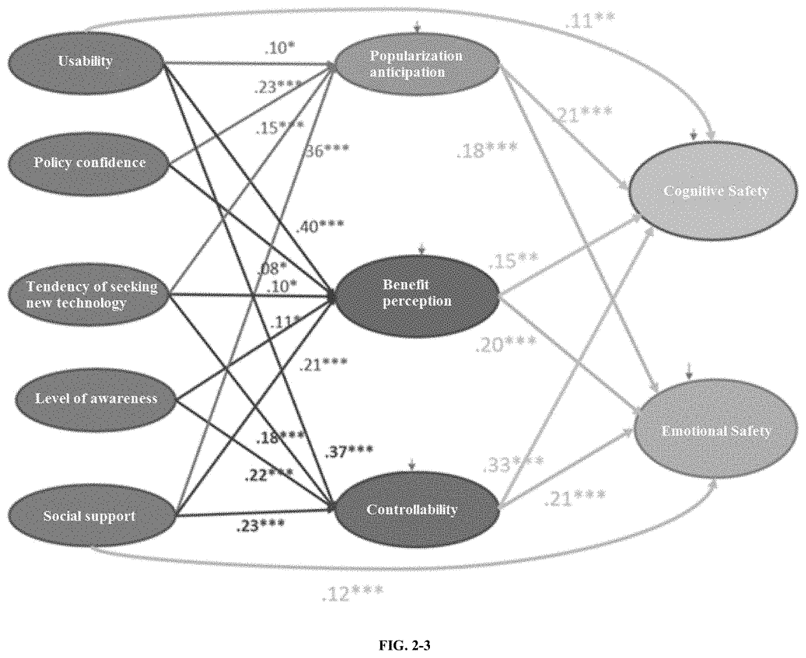

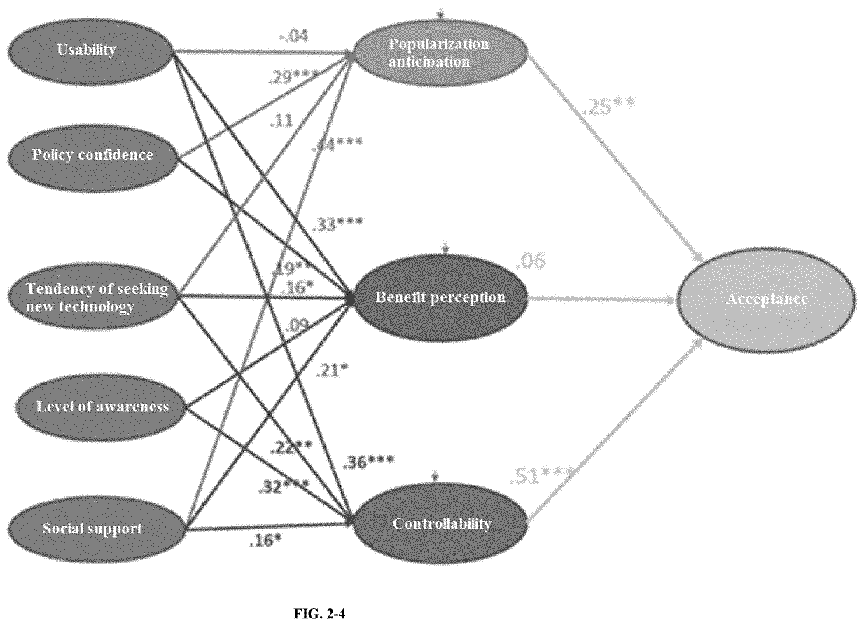

As an embodiment, each functional dimension that is tightly associated with the acceptance dimension may be determined as the functional dimension corresponding to the acceptance dimension. For example, as can be seen from table 4, the functional dimensions that are tightly associated with the acceptance dimension “Level of Awareness”, include “9. Is it easy for the user to understand behaviors of the vehicle?”, “10. Are the feedbacks of the vehicle state and the driving state timely and sufficient?”, “26. Total number of people using the autonomous vehicle at present”, “27. Media coverage and evaluation of the autonomous vehicle”, “28. Comments on the autonomous vehicle from the government or research institutes”, “29. Are there any highly reliable test data reports?”, “30. Policy support or restrictions for the autonomous vehicle” and “31. Recognition and reputation of manufacturers of the autonomous vehicle”. Therefore, it may be determined that the functional dimensions corresponding to the acceptance dimension “Level of Awareness”, are “9. Is it easy for the user to understand behaviors of the vehicle?”, “10. Are the feedbacks of the vehicle state and the driving state timely and sufficient?”, “26. Total number of people using the autonomous vehicle at present”, “27. Media coverage and evaluation of the autonomous vehicle”, “28. Comments on the autonomous vehicle from the government or research institutes”, “29. Are there any highly reliable test data reports?”, “30. Policy support or restrictions for the autonomous vehicle” and “31. Recognition and reputation of manufacturers of the autonomous vehicle”. Analogically, the functional dimensions corresponding to other acceptance dimensions may be determined respectively, so as to form the preset mapping relationship between each functional dimension and each acceptance dimension. FIG. 2-1 illustrates a schematic diagram of the mapping relationship between three acceptance dimensions, i.e., controllability, benefit perception and popularization anticipation, and respective functional dimensions corresponding to them.

In the embodiment of the present disclosure, after determining a features for each of the plurality of functional dimensions of the vehicle to be tested according to the configuration information of the vehicle to be tested, a current acceptance value for each of a plurality of acceptance dimension corresponding to the vehicle to be tested may be determined according to the preset mapping relationship between the functional dimension and the acceptance dimension and the feature for the functional dimension of the vehicle to be tested.

Optionally, the feature for the functional dimension of the vehicle to be tested corresponding to each acceptance dimension may be determined according to the feature for each of the plurality of functional dimensions of the vehicle to be tested, and the acceptance value for each acceptance dimension may be determined according to the number of the features for the functional dimensions of the vehicle to be tested corresponding to each acceptance dimension. That is, the greater the number of the features for the functional dimensions of the vehicle to be tested corresponding to each acceptance dimension is, the greater the acceptance value of each acceptance dimension is. On the other hand, the less the number of the features for the functional dimensions of the vehicle to be tested corresponding to each acceptance dimension is, the less the acceptance value of each acceptance dimension is.

For example, as shown in FIG. 2-2, a schematic diagram of the features for the functional dimensions of a vehicle to be tested corresponding to each acceptance dimension is illustrated. The features for the functional dimensions of the vehicle to be tested that have been determined according to the configuration information of the vehicle to be tested include: emergency braking, physical button-starting/pulling over, physical button-emergency call, preparation of a safety supervisor, sensing and DV-presentation of road conditions, optimization and evaluation of somatesthe, and the like. Accordingly, it may be determined that there are four features for functional dimensions, i.e., emergency braking, a physical button-pulling out/pulling over, a physical button-a button for searching for help, physical button-starting/pulling over, physical button-emergency call, preparation of a safety supervisor, corresponding to the acceptance dimension “controllability” according to the mapping relationship between each functional dimension and each acceptance dimension. In this way, the current acceptance value for the acceptance dimension “controllability” is determined as 4. Analogically, the current acceptance values corresponding to the acceptance dimensions “benefit perception” and “popularization anticipation” are determined to be 2 and 0 respectively. With the same process, the current acceptance values for other acceptance dimensions may also be determined.

It should be noted that the process for determining the current acceptance value for each of the plurality of acceptance dimensions may include, but is not limited to, any examples enumerated above. In practice, the process for determining the current acceptance value for each of the plurality of acceptance dimensions may be preset as necessary, and is not limited to the embodiments of the present disclosure.

In step 103, the user acceptance of the vehicle to be tested is determined according to the current acceptance values for the plurality of the acceptance dimension.

In the embodiment of the present disclosure, after determining the current acceptance value for each of a plurality of acceptance dimensions, the user acceptance of the vehicle to be tested may be determined according to the current acceptance value for each of a plurality of acceptance dimensions.

Optionally, the sum of the current acceptance values for the plurality of the acceptance dimension may be determined as the user acceptance of the vehicle to be tested; or an average value of the current acceptance values for the plurality of the acceptance dimension may be determined as the user acceptance of the vehicle to be tested.

Further, the influence of each acceptance dimension on the user acceptance of the vehicle to be tested may be different. Therefore, the statistical data may be analyzed to determine a relationship between each acceptance dimension and the user acceptance of the vehicle to be tested. Further, each acceptance dimensions may be classified into a direct affecting factor or an indirect affecting factors, or, a mediator variable or an antecedent variable.

Accordingly, in an embodiment of the present disclosure, step 103 may further include: determining a hierarchical relationship among the plurality of acceptance dimensions and conversion weight values among the plurality of acceptance dimensions, and determining the user acceptance of the vehicle to be tested according to the hierarchical relationship among the plurality of acceptance dimensions, the conversion weight values among the plurality of acceptance dimensions, and the current acceptance values for the plurality of the acceptance dimensions.

As an embodiment, the user acceptance of a vehicle to be tested may include two components, i.e., cognitive safety and emotional safety. The correlation between each acceptance dimension and the cognitive safety as well as the correlation between each acceptance dimension and the emotional safety may be expressed with the Pearson correlation coefficient. Further, the mediator variable and antecedent variable in each acceptance dimension may be determined according to the correlation between each acceptance dimension and the cognitive safety and the correlation between each acceptance dimension and the emotional safety. The Pearson's correlation coefficient, also known as the Person product-moment correlation coefficient, indicates the degree of linear correlation and the direction of linear correlation between two variables. The Pearson's correlation coefficient may be denoted by r, with a magnitude between −1 and +1, wherein 1 indicates perfect and positive correlation, −1 indicates perfect and negative correlation, and 0 indicates no correlation. It may be defined mathematically as follows:

$$r = \frac{covariance of X and Y}{deviations of X and Y} = \frac{c o v ( X , Y )}{σ x σ y}$$

Table 5 shows Pearson correlation coefficients between cognitive safety and emotional safety, and eight acceptance dimensions.

TABLE 5

| | Cognitive | Emotional |
|---|---|---|
| | Safety | Safety |
| Tendency of | 0.312** | 0.191** |
| seeking new | | |
| technology | | |
| Policy | 0.238** | 0.178** |
| confidence | | |
| Social support | 0.367** | 0.317** |
| Level of | 0.302** | 0.202** |
| awareness | | |
| Usability | 0.411** | 0.225** |
| Popularization | 0.376** | 0.306** |
| anticipation | | |
| Benefit | 0.419** | 0.309** |
| perception | | |
| Controllability | 0.524** | 0.353** |

It should be noted that the Pearson correlation coefficient reflects a degree of co-variation between every two variables. On the other hand, a partial correlation coefficient reflects the net effect of any antecedent variable on an outcome variable of interest (cognitive safety or emotional safety) when other variables are controlled. It helps to determine the hierarchical relationship in a multi-variable model. That is, in a case where other variables are controlled, variables having significant partial correlation coefficients are the most direct predictor variables (mediator variables) of dependent variables. Further, after other variables are controlled, variables having otherwise significant simple correlation coefficients and insignificant partial correlation coefficients may be more remote predictor variables. That is, the effects of those variables on the dependent variables are reflected through the mediator variables. Table 6 shows partial correlation coefficients between cognitive safety and emotional safety and eight acceptance dimensions, in which each coefficient is net-correlated after the other seven variables are controlled.

TABLE 6

| | Cognitive | Emotional |
|---|---|---|
| | Safety | Safety |
| Tendency of | 0.072 | 0.001 |
| seeking new | | |
| technology | | |
| Policy | 0.060 | 0.052 |
| confidence | | |
| Social support | 0.037 | 0.103* |
| Level of | 0.090 | 0.038 |
| awareness | | |
| Usability | 0.139** | −0.014 |
| Popularization | 0.138** | 0.130** |
| anticipation | | |
| Benefit | 0.115** | 0.114** |
| perception | | |
| Controllability | 0.234** | 0.126** |

As can be seen from tables 5 and 6, the partial correlation coefficients of the popularization anticipation, benefit perception and controllability with respect to the two components of acceptance are still significant, meaning that they may be important mediator variables. The social support has a direct predictive effect on the emotional safety. The usability has a direct predictive effect on the cognitive safety. The seeking tendency for a new technology, policy trust and level of awareness are no longer significant after other variables are controlled, indicating that their effects are likely to be reflected through the effects of the above mediator variables. Therefore, the hierarchical relationship among the acceptance dimensions may be determined as follows, i.e., the popularization anticipation, the benefit perception and the controllability being mediator variables, the other five acceptance dimensions being the antecedent variables, the social support being allowed to predict the emotional safety directly, and the usability being allowed to predict the cognitive safety directly.

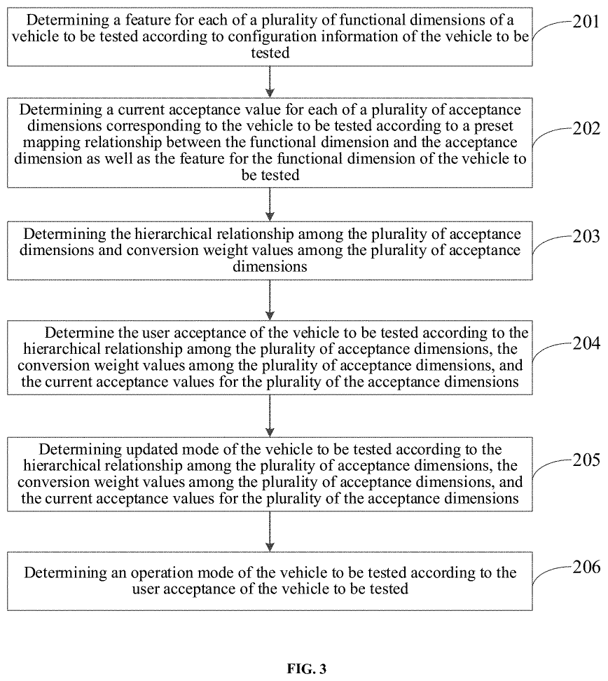

As an embodiment, in order to further clarify the hierarchical relationship among the acceptance dimensions, an analysis may be further performed through a structural equation model, to determine the conversion weight values among the acceptance dimensions, and the reliability of the model. FIGS. 2-3 show schematic diagrams of the structural equation model between the cognitive safety and emotional safety and respective acceptance dimensions, and FIGS. 2-4 further show derived schematic diagrams of the structural equation model between the acceptance and respective acceptance dimensions. Table 7 shows fit indices of the structural equation model between the acceptance and respective acceptance dimensions.

TABLE 7

| CMIN | CMIN/DF | GFI | CFI | TLI | RMSEA |
|---|---|---|---|---|---|
| 977.111 | 2.455 | 0.916 | 0.961 | 0.954 | 0.045 |

It should be noted that, a value of CMIN/DF between 1 and 3 indicates a model having a parsimonious fit; a value of CMIN/DF less than 1 indicates a model having sample uniqueness. When GFI>0.90, CFI>0.90, TLI>0.90, the closer the value is to 1, the better the fit of the model. A value of RMSEA less than 0.08 indicates a reasonable fit, and a value of RMSEA less than 0.05 indicates a good fit. Consequently, table 7 shows that the model fits very well. The numbers above respective arrows in FIGS. 2-3 and 2-4 are the conversion weight values between the acceptance dimensions, which may be standardized regression coefficients of the acceptance dimensions, and may be used for measuring the effect of each acceptance dimension on the acceptance. That is, the greater the standardized regression coefficient of the acceptance dimension, the greater its effect on the acceptance and/or the two components of the acceptance.

It may be understood that the effects of the mediator variables on the acceptance and/or the two components of the acceptance are direct effects, and the effects of the antecedent variables on the acceptance and/or the two components of the acceptance are indirect effects. By extracting and summarizing the direct and indirect effects in the structural equation model, the direct effects, indirect effects and total effects of respective acceptance dimensions on the acceptance, and/or on the two components of the acceptance may be obtained. Table 8 illustrates the direct effects, indirect effects and total effects of respective acceptance dimensions on the two components of the acceptance (i.e., the cognitive safety, emotional safety).

TABLE 8

| | Cognitive Safety | | | Emotional Safety | | |
|---|---|---|---|---|---|---|
| | Direct | Indirect | Total | Direct | Indirect | Total |
| | Effect | Effect | Effect | Effect | Effect | Effect |
| Tendency of | 0 | 0.107 | 0.107 | 0 | 0.083 | 0.083 |
| seeking new | | | | | | |
| technology | | | | | | |
| Policy | 0 | 0.060 | 0.060 | 0 | 0.056 | 0.056 |
| confidence | | | | | | |
| Social support | 0 | 0.184 | 0.184 | 0.121 | 0.153 | 0.274 |
| Level of | 0 | 0.090 | 0.090 | 0 | 0.067 | 0.067 |
| awareness | | | | | | |
| Usability | 0.111 | 0.202 | 0.313 | 0 | 0.171 | 0.171 |
| Popularization | 0.214 | 0 | 0.214 | 0.181 | 0 | 0.181 |
| anticipation | | | | | | |
| Benefit | 0.150 | 0 | 0.150 | 0.196 | 0 | 0.196 |
| perception | | | | | | |
| Controllability | 0.330 | 0 | 0.330 | 0.204 | 0 | 0.204 |

It should be noted that the direct effect of any one of the acceptance dimensions on the cognitive safety or the emotional safety is the standardized regression coefficient (i.e., the conversion weight value) above the arrow that is directly pointing from the acceptance dimension to the cognitive safety or the emotional safety. Further, the indirect effect of any one of the acceptance dimensions on the cognitive safety or the emotional safety is a sum of the products of the conversion weight values on all the paths that are pointing from the acceptance dimension to the cognitive safety or the emotional safety through other mediator variables. For example, the direct effect of the acceptance dimension “controllability” on the cognitive safety is 0.33, and there is no indirect effect since there is no process through an mediator variable. The direct effect of usability on the cognitive safety is 0.11; the effect of the usability on the cognitive safety through the popularization anticipation is 0.10*0.21=0.021; the effect of the usability on the cognitive safety through the benefit perception is 0.40*0.15=0.06; and the effect of the usability on the cognitive safety through the controllability is 0.37*0.33=0.1221. Accordingly, the total indirect effect of the usability is 0.021+0.06+0.1221=0.2021. The total effect of any one of the acceptance dimensions on the cognitive safety or emotional safety is a sum of its direct and indirect effects on the cognitive safety and the emotional safety.

In the embodiment of the present disclosure, after the hierarchical relationship among the plurality of acceptance dimensions, the conversion weight values among the plurality of acceptance dimensions, and the current acceptance values for the plurality of the acceptance dimensions are determined, the user acceptance of the vehicle to be tested may be determined according to the hierarchical relationship among the plurality of acceptance dimensions, the conversion weight values among the plurality of acceptance dimensions, and the current acceptance values for the plurality of the acceptance dimensions. Optionally, the user acceptance of the vehicle to be tested may be determined by the following expression (1).

A=Σᵢ₌₁ⁿaᵢ·wᵢ (1)

Here, A is the user acceptance of the vehicle to be tested; aᵢ is a current acceptance value of an ith acceptance dimension; wᵢ is a conversion weight value of the ith acceptance dimension; n is the number of the acceptance dimensions; and i is a sequence number of the acceptance dimension.

It should be noted that the method of determining the user acceptance of the vehicle to be tested may include, but is not limited to, the examples enumerated above. In practice, the method of determining the user acceptance of the vehicle to be tested may be preset as necessary, and is not limited to the embodiment of the present disclosure.

The method for measuring the user acceptance of the autonomous vehicle, the apparatus, the electronic device, the computer readable storage medium and the computer program according to the embodiments of the present disclosure may determine a feature for each of a plurality of functional dimension of a vehicle to be tested according to configuration information of the vehicle to be tested; determine a current acceptance value for each of a plurality of acceptance dimensions corresponding to the vehicle to be tested, according to a preset mapping relationship between the functional dimension and the acceptance dimension as well as the feature for the functional dimension of the vehicle to be tested; and determine the user acceptance of the vehicle to be tested according to the current acceptance values for the plurality of the acceptance dimensions. Consequently, by determining the user acceptance of the vehicle to be tested according to the configuration information of the vehicle to be tested and the preset mapping relationship between each functional dimension and each acceptance dimension, the user acceptance of the autonomous vehicle may be measured accurately for guiding and supporting the development and operation of the autonomous vehicle.

In an embodiment of the present disclosure, after determining the user acceptance of the vehicle to be tested, the performance of the vehicle to be tested may be improved or the operation of the vehicle to be tested may be guided according to the user acceptance of the vehicle to be tested.

The method for measuring the user acceptance of the autonomous vehicle according to the embodiment of the present disclosure will be further described with reference to FIG. 3.

FIG. 3 is a flow chart of a method for measuring user acceptance of an autonomous vehicle according to another embodiment of the present disclosure.

As shown in FIG. 3, the method for measuring the user acceptance of the autonomous vehicle includes the following steps.

In step 201, a feature for each of a plurality of functional dimensions of a vehicle to be tested is determined according to configuration information of the vehicle to be tested.

Specific implementations and principle of step 201 may be similar to those in the foregoing embodiments, and details are thus omitted here.

In step 202, a current acceptance value for each of a plurality of acceptance dimensions corresponding to the vehicle to be tested is determined according to a preset mapping relationship between the functional dimension and the acceptance dimension as well as the feature for the functional dimension of the vehicle to be tested.

In the embodiment of the present disclosure, after determining the feature for each of a plurality of functional dimensions of a vehicle to be tested according to configuration information of the vehicle to be tested, the current acceptance value for each of a plurality of acceptance dimensions may be determined according to the preset mapping relationship between the functional dimension and the acceptance dimension as well as the feature for the functional dimension of the vehicle to be tested. Specific implementations and principle for determining the current acceptance value for each of a plurality of acceptance dimensions may be similar to those in the foregoing embodiments, and details are thus omitted here.

Further, during the designing process and manufacturing process the vehicle to be tested, a target operation environment of the vehicle to be tested may be limited, and various functions of the vehicle to be tested may be designed according to the target operation environment of the vehicle to be tested. However, the target operation environment of the vehicle to be tested may be different from the actual operation environment in the survey, leading to inaccurate determination of the current acceptance values for each of a plurality of acceptance dimensions corresponding to the vehicle to be tested. Accordingly, in an embodiment of the present disclosure, after step 202, the method may further include: obtaining a target operation environment corresponding to the vehicle to be tested; and correcting the current acceptance value for each of the plurality of acceptance dimensions corresponding to the vehicle to be tested according to a difference between the target operation environment and a current actual operation environment.

It should be noted that the vehicle to be tested may be a vehicle with some special functions. For example, the vehicle to be tested may be an autonomous vehicle for delivering packages on campus, or an autonomous vehicle for rallying. Therefore, vehicles to be verified for different uses may correspond to different target operation environments, resulting in differences between the target operation environments corresponding to the vehicles to be verified for different uses and the actual operation environments in which the statistical data is collected. For this reason, there may be deviations between the current acceptance value for each of a plurality of acceptance dimensions determined according to the preset mapping relationship between the functional dimension and the acceptance dimension and the acceptance value for each of a plurality of acceptance dimensions of the vehicle to be tested in its target operation environment. That is, in the embodiment of the present disclosure, the current acceptance value for each of a plurality of acceptance dimensions corresponding to the vehicle to be tested may be corrected to improve the reliability of the resultant acceptance value of each acceptance dimension.

As an embodiment, the target operation environment of the vehicle to be tested may be obtained from the configuration information of the vehicle to be tested, or from guidance information such as a user manual of the vehicle to be tested. Then, the difference between the target operation environment and the actual operation environment under test is determined. Then, the current acceptance value for each of the plurality of acceptance dimensions corresponding to the vehicle to be tested is corrected according to the difference between the target operation environment and the current actual operation environment.

Optionally, the functional dimension corresponding to difference information may be first determined according to the difference between the target operation environment and the current actual operation environment. Then, the acceptance dimension having a mapping relationship with the functional dimension corresponding to the difference information is determined according to the mapping relationship between the functional dimension and the acceptance dimension. When the target operation environment of the vehicle to be tested requires the vehicle to be tested to have the features for the functional dimensions corresponding to the difference information, and the current actual operation environment does not require the vehicle to be tested to have the features for the functional dimensions corresponding to the difference information, that is, the target operation environment is stricter than the current actual operation environment, the current acceptance value of the acceptance dimension having the mapping relationship with the functional dimension corresponding to the difference information may be corrected to a smaller value. When the target operation environment of the vehicle to be tested does not require the vehicle to be tested to have the features for the functional dimensions corresponding to the difference information, and the current actual operation environment requires the vehicle to be tested to have the features for the functional dimensions corresponding to the difference information, that is, the target operation environment is simpler than the current actual operation environment, the current acceptance value of the acceptance dimension having the mapping relationship with the functional dimension corresponding to the difference information may be corrected to a larger value.

It should be noted that the method of correcting the current acceptance value of each acceptance dimension corresponding to the vehicle to be tested may include, but is not limited to, examples enumerated above. In practice, the correction method may be preset as necessary, and is not limited to the embodiments of the present disclosure.

In step 203, the hierarchical relationship among the plurality of acceptance dimensions and conversion weight values among the plurality of acceptance dimensions are determined.

In step 204, the user acceptance of the vehicle to be tested is determined according to the hierarchical relationship among the plurality of acceptance dimensions, the conversion weight values among the plurality of acceptance dimensions, and the current acceptance values for the plurality of the acceptance dimensions.

Specific implementations and principle of steps 203-204 may be similar to those in the foregoing embodiments, and details are thus omitted here.

In step 205, an updated mode of the vehicle to be tested is determined according to the hierarchical relationship among the plurality of acceptance dimensions, the conversion weight values among the plurality of acceptance dimensions, and the current acceptance values for the plurality of the acceptance dimensions.

In the embodiment of the present disclosure, the importance of each acceptance dimension may be determined according to the hierarchical relationship among the plurality of acceptance dimensions and the conversion weight values among the plurality of acceptance dimensions. Then, each acceptance dimension with a relatively high level of importance and preferably depending on the capability of the vehicle to be tested may be determined according to the importance of each acceptance dimension. Then, the updated mode of the vehicle to be tested is determined according to the current acceptance values of the acceptance dimensions with a relatively high level of importance and preferably depending on the capability of the vehicle to be tested. In this way, the capability of the vehicle to be tested may be improved according to the determined updated mode.

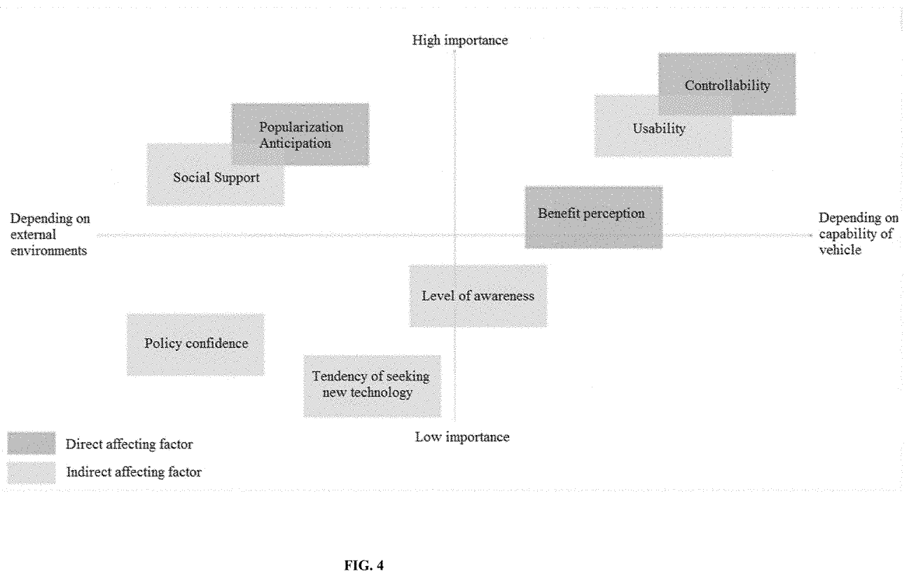

For example, when the acceptance dimensions include controllability, benefit perception, popularization anticipation, usability, level of awareness, social support, policy trust and tendency of seeking new technology, according to the foregoing discussion on the hierarchical relationship among the acceptance dimensions and the conversion weight value between the acceptance dimensions, the acceptance dimensions with a relatively high level of importance may be determined as controllability, benefit perception, popularization anticipation, usability and social support, in which the controllability, benefit perception and usability depend on the capability of the vehicle. FIG. 4 is a schematic diagram showing the distribution of importance of each acceptance dimension and the distribution of their dependent resources. It may be intuitively seen from FIG. 4 that controllability, benefit perception and usability have a relatively high level of importance and depend on the capability of the vehicle to be tested preferably. Therefore, the updated mode of the vehicle to be tested may be determined according to the current acceptance values of the controllability, benefit perception and usability.

As an embodiment, after each acceptance dimension with a relatively high level of importance and preferably depending on the capability of the vehicle to be tested, the feature for each of a plurality of the functional dimensions of the vehicle to be tested corresponding to the acceptance dimensions with low current acceptance values may be improved according to the current acceptance value for each of the plurality of acceptance dimensions with relatively high levels of importance and preferably depending on the capability of the vehicle to be tested, thereby increasing the acceptance values of corresponding acceptance dimensions. That is, the functions of the vehicle to be tested per se may be improved so that the functional features of the vehicle to be tested more fit the functional dimensions corresponding to respective acceptance dimensions.

For example, when the acceptance dimensions with high levels of importance and preferably depending on the capability of the vehicle to be tested are determined as controllability, benefit perception and usability, the updated mode shown in table 9 may be determined. The updated mode includes three primary-level sub-targets, i.e., improving controllability, improving popularization anticipation, and improving benefit perception, and a plurality of secondary-level sub-targets corresponding to the three primary-level sub-targets respectively.

TABLE 9
Updated Mode Framework

| Primary-level | | |
|---|---|---|
| sub-targets | Secondary-level sub-targets | Specific Means and Suggestions |
| Improving | Improving | Providing a help-seeking mode that may |
| controllability | directly | be enabled at any time; |
| | | Providing an one-touch emergency function; |
| | | Providing a function enabling a person to |
| | | intervene in the operation of the vehicle at any |
| | | time; and Presence of a human safety |
| | | supervisor or not and his professionalism |
| | Through improving usability | Providing feedbacks timely, and responding |
| | | promptly and correctly, or providing a transient |
| | | response; |
| | | Providing buttons for redundant governance; |
| | | Providing functions of error feedback and |
| | | compliant; |
| | | Delivering system information and system |
| | | intentions timely; |
| | | Understanding traffic conditions around |
| | | the vehicles comprehensively (from |
| | | God's perspective); and Controlling |
| | | external environments (e.g., through |
| | | interactions with other vehicles) |
| | Through improving level of social | Creating a social environment to provide social |
| | support | support, such as creating a communication |
| | | group for users of the autonomous vehicles; |
| | | Drawing support from specific groups, such as the |
| | | aged, women, children, etc.; and |
| | | Presenting propaganda films that appeal to |
| | | emotions, and so on. |
| | Through improving | Reports on whether it is possible to |
| | individuals' awareness of | brake the vehicle reliably in emergency; |
| | the autonomous vehicle | Reports on possibilities and severity of accidents |
| | | and faults, and comparison with respective |
| | | to those of traditional vehicles; |
| | | Exceptional circumstances; |
| | | Improving user' intuitive impression |
| | | through a test ride |
| | Through seeking | Selecting users of new technology who may play a |
| | individuals who tend to | leading role accurately through a big data analysis, |
| | seek new technology | and finding out their objectives of leading social |
| | | trends as well as appropriate propagandistic styles |
| Improving | Improving directly | Providing specific evidences of roads, devices, |
| popularization | | after-sales service, policies and regulations; |
| anticipation | | Unveiling technical developments of the |
| | | autonomous vehicles as well as updating and |
| | | progress in policies and regulations timely |
| | Through improving level | Promoting with the help of |
| | of social support | well-known individuals; Publicizing laws and |
| | | regulations by means of manufacturers with |
| | | high recognition and reputation |
| | Through improving individuals' | Perfected, operational and sustainable regulations; |
| | confidence in policy | Taking lead in practical usage and making |
| | | commitments by government officials and civil |
| | | servants; |
| | | publishing objective surveys and test |
| | | results from a third-party perspective through |
| | | cooperation with national authorities |
| | Through seeking individuals who | Ditto |
| | tend to seek new technology | |
| | Through improving usability | Ditto |
| Improving | Improving directly | Improving an overall function, using promotions, |
| benefit | | and helping users form understanding and an |
| perception | | appropriate anticipation on benefits of autonomous |
| | | vehicles by displaying specific benefits to the users |
| | | through detailed description of the scene |
| | Through improving usability | Ditto |
| | Through improving level | Ditto |
| | of social support | |
| | Through improving individuals' | Ditto |
| | confidence in policy | |
| | Through improving individuals' | Ditto |
| | awareness of the | |
| | autonomous vehicle | |
| | Through seeking individuals who | Ditto |
| | tend to seek new technology | |

In step 206, an operation mode of the vehicle to be tested is determined according to the user acceptance of the vehicle to be tested.

The operation modes of the vehicle to be tested may include sales, lease, full-automatic operation, semi-automatic driving operation and so on.

In the embodiment of the present disclosure, the operation mode of the vehicle to be tested may be determined according to the user acceptance of the vehicle to be tested. That is, the operation mode of the vehicle to be tested may be guided according to the user acceptance of the vehicle to be tested.

Optionally, when the user acceptance of the vehicle to be tested is low, that is, when the user thinks that the vehicle to be tested has a low level of safety, the operation mode of the vehicle to be tested may be determined as a semi-automatic driving operation, in which the vehicle to be tested is equipped with a safety supervisor for intervening in the operation of the vehicle as necessary. When the user acceptance of the vehicle to be tested is high, that is, when the user thinks that the vehicle to be tested has a high level of safety, the operation mode of the vehicle to be tested may be determined as full-automatic operation. Or otherwise, the operation mode of the vehicle to be tested may be determined to be sales or lease, so that the vehicle with a high level of safety may be put on the market.

It should be noted that the operation mode of the vehicle to be tested, and the correspondence between the user acceptance of the vehicle to be tested and the operation mode of the vehicle to be tested may include, but are not limited to, any examples enumerated above. In practice, the operation mode and the correspondence may be preset as necessary, and is not limited to the embodiments of the present disclosure.

The method for measuring the user acceptance of the autonomous vehicle may determine a feature for each of a plurality of functional dimension of a vehicle to be tested according to configuration information of the vehicle to be tested; determine a current acceptance value for each of a plurality of acceptance dimensions corresponding to the vehicle to be tested, according to a preset mapping relationship between the functional dimension and the acceptance dimension as well as the feature for the functional dimension of the vehicle to be tested; determine the user acceptance of the vehicle to be tested and the updated mode of the vehicle to be tested according to the hierarchical relationship among the plurality of acceptance dimensions, the conversion weight values among the plurality of acceptance dimensions, and the current acceptance values for the plurality of the acceptance dimensions, and then determine the operation mode of the vehicle to be tested according to the user acceptance of the vehicle to be tested. Consequently, the current acceptance value for each of a plurality of acceptance dimensions corresponding to the vehicle to be tested may be determined according to a preset mapping relationship between the functional dimension and the acceptance dimension as well as the feature for the functional dimension of the vehicle to be tested, and the user acceptance of the vehicle to be tested and the updated mode of the vehicle to be tested may be determined according to the hierarchical relationship among the plurality of acceptance dimensions, the conversion weight values among the plurality of acceptance dimension. In this way, the user acceptance of the autonomous vehicle may be measured accurately for guiding and supporting the development and operation of the autonomous vehicle.

To implement the above embodiments, the present disclosure further provides an apparatus for measuring user acceptance of an autonomous vehicle.

FIG. 5 is a schematic structure diagram of an apparatus for measuring user acceptance of an autonomous vehicle according to an embodiment of the present disclosure.

As illustrated in FIG. 5, the apparatus 30 for measuring the user acceptance of the autonomous vehicle includes a first determination module 31, a second determination module 32 and a third determination module 33.

The first determination module 31 is configured to determine a feature for each of a plurality of functional dimensions of a vehicle to be tested according to configuration information of the vehicle to be tested.

The second determination module 32 is configured to a current acceptance value for each of a plurality of acceptance dimensions corresponding to the vehicle to be tested, according to a preset mapping relationship between the functional dimension and the acceptance dimension as well as the feature for the functional dimension of the vehicle to be tested.

The third determination module 33 is configured to determine the user acceptance of the vehicle to be tested according to the current acceptance values for the plurality of the acceptance dimensions.

In practice, the apparatus for measuring the user acceptance of the autonomous vehicle provided by the embodiment of the present disclosure may be configured in any electronic device to perform the aforementioned method for measuring the user acceptance of the autonomous vehicle.

The apparatus for measuring the user acceptance of the autonomous vehicle according to the embodiment of the present disclosure may determine a feature for each of a plurality of functional dimension of a vehicle to be tested according to configuration information of the vehicle to be tested; determine a current acceptance value for each of a plurality of acceptance dimensions corresponding to the vehicle to be tested, according to a preset mapping relationship between the functional dimension and the acceptance dimension as well as the feature for the functional dimension of the vehicle to be tested; and determine the user acceptance of the vehicle to be tested according to the current acceptance values for the plurality of the acceptance dimensions. Consequently, by determining the user acceptance of the vehicle to be tested according to the configuration information of the vehicle to be tested and the preset mapping relationship between each functional dimension and each acceptance dimension, the user acceptance of the autonomous vehicle may be measured accurately for guiding and supporting the development and operation of the autonomous vehicle.

In an embodiment of the present disclosure, the apparatus 30 for measuring the user acceptance of the autonomous vehicle further includes a fourth determination module.

The fourth determination module is configured to perform statistical analysis on data in a statistical data collection by using a structural equation model, to determine the preset mapping relationship between the functional dimension and the acceptance dimension.

Further, in another embodiment of the present disclosure, the apparatus 30 for measuring the user acceptance of the autonomous vehicle may further include a fifth determination module.

The fifth determination module is configured to determine the hierarchical relationship among the plurality of acceptance dimensions and the conversion weight values among the plurality of acceptance dimensions.

Correspondingly, the third determination module 33 is specifically configured to: determine the user acceptance of the vehicle to be tested according to the hierarchical relationship among the plurality of acceptance dimensions, the conversion weight values among the plurality of acceptance dimensions, and the current acceptance values for the plurality of the acceptance dimensions.

Further, in another embodiment of the present disclosure, the apparatus 30 for measuring the user acceptance of the autonomous vehicle may further include a sixth determination module.

The sixth determination module is configured to determine an updated mode of the vehicle to be tested according to the hierarchical relationship among the plurality of acceptance dimensions, the conversion weight values among the plurality of acceptance dimensions, and the current acceptance values for the plurality of the acceptance dimensions.

Further, in another embodiment of the present disclosure, the apparatus 30 for measuring the user acceptance of the autonomous vehicle may further include a seventh determination module.

The seventh determination module is configured to determine an operation mode of the vehicle to be tested according to the user acceptance of the vehicle to be tested.

Further, in another possible implementation of the present disclosure, the apparatus 30 for measuring the user acceptance of the autonomous vehicle may further include an obtaining module and a correction module.

The obtaining module is configured to obtain a target operation environment corresponding to the vehicle to be tested.

The correction module is configured to correct the current acceptance value for each of the plurality of acceptance dimensions corresponding to the vehicle to be tested according to a difference between the target operation environment and a current actual operation environment.

It should be noted that the explanation of the embodiments of the method for measuring the user acceptance of the autonomous vehicle shown in FIGS. 1 and 3 is also applicable to the apparatus 30 for measuring the user acceptance of the autonomous vehicle according to the embodiment, and thus no repetition is made herein.

The apparatus for measuring the user acceptance of the autonomous vehicle according to the embodiment of the present disclosure may determine a feature for each of a plurality of functional dimension of a vehicle to be tested according to configuration information of the vehicle to be tested; determine a current acceptance value for each of a plurality of acceptance dimensions corresponding to the vehicle to be tested, according to a preset mapping relationship between the functional dimension and the acceptance dimension as well as the feature for the functional dimension of the vehicle to be tested; determine the user acceptance of the vehicle to be tested and the updated mode of the vehicle to be tested according to the hierarchical relationship among the plurality of acceptance dimensions, the conversion weight values among the plurality of acceptance dimensions, and the current acceptance values for the plurality of the acceptance dimensions, and then determine the operation mode of the vehicle to be tested according to the user acceptance of the vehicle to be tested. Consequently, the current acceptance value for each of a plurality of acceptance dimensions corresponding to the vehicle to be tested may be determined according to a preset mapping relationship between the functional dimension and the acceptance dimension as well as the feature for the functional dimension of the vehicle to be tested, and the user acceptance of the vehicle to be tested and the updated mode of the vehicle to be tested may be determined according to the hierarchical relationship among the plurality of acceptance dimensions, the conversion weight values among the plurality of acceptance dimension. In this way, the user acceptance of the autonomous vehicle may be measured accurately for guiding and supporting the development and operation of the autonomous vehicle.

To implement the above embodiment, the present disclosure further provides an electronic device.

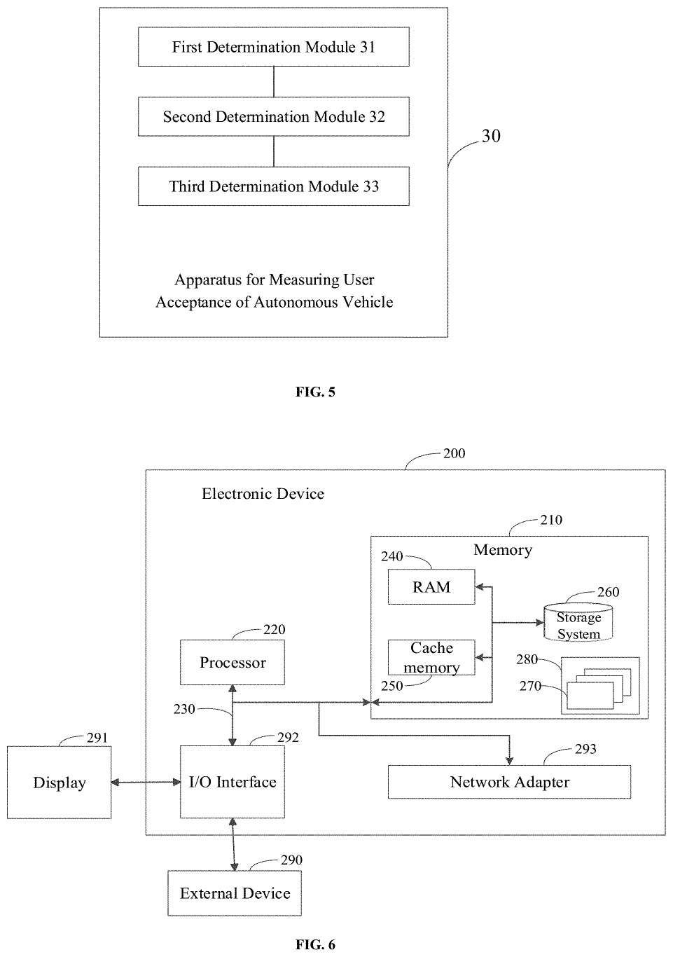

FIG. 6 is a schematic structure diagram of an electronic device according to an embodiment of the present disclosure.

As shown in FIG. 6, an electronic device 200 includes: a memory 210, a processor 220 and a bus 230 connecting different components (including the memory 210 and the processor 220). When the processor 220 executes the program, the processor 220 implements the method for measuring the user acceptance of the autonomous vehicle according to the embodiment of the present disclosure.

The bus 230 may be implemented as one or more bus architectures, including a storage device bus or a storage device controller, a peripheral bus, an accelerated graphics port, a processor, or a local bus with any of the bus architectures. For example, the bus architectures include, but are not limited to, an industry subversive alliance (ISA) bus, a micro channel architecture (MAC) bus, an enhanced ISA bus, a video electronics standards association (VESA) local bus and a peripheral component interconnect (PCI) bus.

The electronic device 200 typically includes various electronic device readable media. The media may be any available media that may be accessed by the electronic device 200, including volatile and non-volatile media, removable and non-removable media.

The memory 210 may include a computer system readable medium in the form of a volatile memory, such as a random access memory (RAM) 240 and/or a cache memory 250. The electronic device 200 may further include other removable/non-removable and volatile/non-volatile computer system storage media. As an example only, a storage system 260 may be configured to read from or write to a non-removable and non-volatile magnetic medium (not shown in FIG. 6, and generally referred as a “hard disk drive”). Although not shown in FIG. 6, a magnetic-disk drive configured to read from or write to a removable and nonvolatile magnetic disk (for example, a “floppy disk”), and an optical-disk drive configured to read from or write to a removable and nonvolatile optical disk, such as a CD-ROM, a DVD-ROM, or other optical media, may be provided. In those cases, each drive may be connected to the bus 230 through one or more data medium interfaces. The memory 210 may include at least one program product having a set of (e.g., at least one) program modules configured to perform functions in respective embodiments of the present disclosure.

A program/utility 280 having a set of (at least one) program modules 270 may be stored, for example, in the memory 210. The program modules 270 include, but are not limited to, an operation system, one or more applications, other program modules and program data. Each of the examples or a certain combination thereof may include an implementation of a network environment. The program module 270 typically performs the functions and/or methods in the embodiments described in the disclosure.

Further, the electronic device 200 may communicate with one or more external devices 290, such as a keyboard, a pointing device and a display 291, and may also communicated with one or more terminals that enable the user to interact with the electronic device 200, and/or communicate with any terminals, such as a network card and a modem, that enable the electronic device 200 to communicate with one or more other computer terminals. Such communication may be implemented through an input/output (I/O) interface 292. In addition, the electronic device 200 may also communicate with one or more networks, such as a local area network (LAN), a wide area network (WAN), and/or a public network such as the Internet, through a network adapter 293. As shown in FIG. 6, the network adapter 293 may communicates with other modules in the electronic device 200 through the bus 230. It should be understood that, although not shown in the drawings, other hardware and/or software modules may be utilized in combination with the electronic device 200, including but not limited to: a microcode, a terminal driver, a redundant processor, external disk drive arrays, a redundant-arrays-of-independent-disks (RAID) system, a tape drive, and a data backup storage system.

The processor 220 performs various functional applications and data processing by running programs stored in the memory 210.

It should be noted that reference to the implementation process and technical principles of the electronic device according to this embodiment may be made to the foregoing description of the method for measuring the user acceptance of the autonomous vehicle according to the above embodiments of the present disclosure, and thus details are not described herein again.

The electronic device according to the embodiment of the present disclosure may execute the method for measuring the user acceptance of the autonomous vehicle as described above, may determine a feature for each of a plurality of functional dimension of a vehicle to be tested according to configuration information of the vehicle to be tested; determine a current acceptance value for each of a plurality of acceptance dimensions corresponding to the vehicle to be tested, according to a preset mapping relationship between the functional dimension and the acceptance dimension as well as the feature for the functional dimension of the vehicle to be tested; and determine the user acceptance of the vehicle to be tested according to the current acceptance values for the plurality of the acceptance dimensions. Consequently, by determining the user acceptance of the vehicle to be tested according to the configuration information of the vehicle to be tested and the preset mapping relationship between each functional dimension and each acceptance dimension, the user acceptance of the autonomous vehicle may be measured accurately for guiding and supporting the development and operation of the autonomous vehicle.

To implement the above embodiment, the present disclosure further provides a computer readable storage medium.

The computer readable storage medium has a computer program stored thereon, wherein when the program is executed by a processor, the program implements the method for measuring the user acceptance of the autonomous vehicle according to the embodiment.

To implement the above embodiment, an embodiment of another aspect of the present disclosure provides a computer program. When the program is executed by the processor, the program implements the method for measuring the user acceptance of the autonomous vehicle according to the embodiment.

In a possible implementation, the embodiment may adopt any combination of one or more computer readable media. The computer readable medium may be a computer readable signal medium or a computer readable storage medium. The computer readable storage medium may be, for example, but not limited to, electronic, magnetic, optical, electromagnetic, infrared, or semiconducting system, apparatus, or device, or any combination of them. More specifically, but not listed exhaustively, examples of the computer readable storage medium may include: an electrical connection with one or more wires, a portable computer disk, a hard disk, a random access memory (RAM), a read only memory (ROM), an erasable programmable read only memory (EPROM or a flash memory), an optical fiber, a portable compact disk-read only memory (CD-ROM), an optical storage device, a magnetic storage device, or any suitable combination of them. In this application, a computer readable storage medium may be any tangible medium that contains or stores a program to be utilized by or in connection with an instruction execution system, apparatus, or device.

A computer readable signal medium may include a data signal that is propagated in a baseband or as part of a carrier, carrying computer readable program codes. The data signal propagated in this manner may adopt a plurality of forms including, but not limited to, an electromagnetic signal, an optical signal, or any suitable combination thereof. The computer readable signal medium may also be any computer readable medium other than a computer readable storage medium. The computer readable medium may send, propagate, or transmit a program to be utilized by or in connection with an instruction execution system, apparatus, or device.

Program codes contained in the computer readable medium may be transmitted over any suitable media, including but not limited to a wireless connection, a wired connection, a fiber optic cable, RF, or any suitable combination thereof.

Computer program codes for performing the operations of the present disclosure may be written in one or more programming languages, or a combination thereof. The programming languages may include an object-oriented programming language such as Java, Smalltalk, C++, and conventional procedural programming languages such as the C language or the like. The program codes may be entirely executed on the user's computer, partly executed on the user's computer, executed as a stand-alone software package, executed partly on the user's computer and partly on a remote computer, or entirely executed on the remote computer or terminal. In a case involving the remote computer, the remote computer may be connected to the user's computer through any kind of network, including a local area network (LAN) or a wide area network (WAN), or may be connected to an external computer, for example, through the Internet provided by an Internet service provider.

Other embodiments of the present disclosure will be apparent to those skilled in the art from consideration of the specification and practice of the present disclosure disclosed here. This application is intended to cover any variations, uses, or adaptations of the present disclosure following the general principles thereof and including such departures from the present disclosure as come within known or customary practice in the art. It is intended that the specification and examples be considered as exemplary only, with a true scope and spirit of the present disclosure being indicated by the following claims.

It will be appreciated that the present disclosure is not limited to the exact construction that has been described above and illustrated in the accompanying drawings, and that various modifications and changes can be made without departing from the scope thereof. It is intended that the scope of the present disclosure can only be limited by the appended claims.

What is claimed is:

1. A method for measuring user acceptance of an autonomous vehicle, comprising:
determining a feature for each of a plurality of functional dimensions of a vehicle to be tested according to configuration information of the vehicle to be tested;
determining a current acceptance value for each of a plurality of acceptance dimensions corresponding to the vehicle to be tested, according to a preset mapping relationship between the functional dimension and the acceptance dimension as well as the feature for the functional dimension of the vehicle to be tested; and
determining the user acceptance of the vehicle to be tested according to the current acceptance values for the plurality of the acceptance dimensions.

2. The method according to claim 1, before determining the current acceptance value for each of the plurality of acceptance dimensions corresponding to the vehicle to be tested, further comprising:
performing statistical analysis on data in a statistical data collection by using a structural equation model, to determine the preset mapping relationship between the functional dimension and the acceptance dimension.

3. The method according to claim 2, after performing the statistical analysis on the data in the statistical data collection by using the structural equation model, further comprising:
determining a hierarchical relationship among the plurality of acceptance dimensions and conversion weight values among the plurality of acceptance dimensions, and
determining the user acceptance of the vehicle to be tested according to the current acceptance values for the plurality of the acceptance dimensions comprises:
determining the user acceptance of the vehicle to be tested according to the hierarchical relationship among the plurality of acceptance dimensions, the conversion weight values among the plurality of acceptance dimensions, and the current acceptance values for the plurality of the acceptance dimensions.

4. The method according to claim 3, after determining the current acceptance value for each of the plurality of acceptance dimensions corresponding to the vehicle to be tested, further comprising:
determining an updated mode of the vehicle to be tested according to the hierarchical relationship among the plurality of acceptance dimensions, the conversion weight values among the plurality of acceptance dimensions, and the current acceptance values for the plurality of the acceptance dimensions.

5. The method according to claim 1, after determining the user acceptance of the vehicle to be tested, further comprising:
determining an operation mode of the vehicle to be tested according to the user acceptance of the vehicle to be tested.

6. The method according to claim 1, after determining the current acceptance value for each of the plurality of acceptance dimensions corresponding to the vehicle to be tested, further comprising:
obtaining a target operation environment corresponding to the vehicle to be tested; and
correcting the current acceptance value for each of the plurality of acceptance dimensions corresponding to the vehicle to be tested according to a difference between the target operation environment and a current actual operation environment.

7. An apparatus for measuring user acceptance of an autonomous vehicle, comprising:
one or more processors; and
a storage device, configured to store one or more programs,
wherein, when the one or more programs are executed by the one or more processors, the one or more processors are configured to implement a method for measuring user acceptance of an autonomous vehicle, comprising:
determining a feature for each of a plurality of functional dimensions of a vehicle to be tested according to configuration information of the vehicle to be tested;
determining a current acceptance value for each of a plurality of acceptance dimensions corresponding to the vehicle to be tested, according to a preset mapping relationship between the functional dimension and the acceptance dimension as well as the feature for the functional dimension of the vehicle to be tested; and
determining the user acceptance of the vehicle to be tested according to the current acceptance values for the plurality of the acceptance dimensions.

8. The apparatus according to claim 7, wherein the one or more processors are further configured, before determining the current acceptance value for each of the plurality of acceptance dimensions corresponding to the vehicle to be tested, to:
perform statistical analysis on data in a statistical data collection by using a structural equation model, to determine the preset mapping relationship between the functional dimension and the acceptance dimension.

9. The apparatus according to claim 8, wherein the one or more processors are further configured, after performing the statistical analysis on the data in the statistical data collection by using the structural equation model, to:
determine a hierarchical relationship among the plurality of acceptance dimensions and conversion weight values among the plurality of acceptance dimensions, and
when the one or more processors are configured to determine the user acceptance of the vehicle to be tested according to the current acceptance values for the plurality of the acceptance dimensions, the one or more processors are configured to:
determine the user acceptance of the vehicle to be tested according to the hierarchical relationship among the plurality of acceptance dimensions, the conversion weight values among the plurality of acceptance dimensions, and the current acceptance values for the plurality of the acceptance dimensions.

10. The apparatus according to claim 9, wherein the one or more processors are further configured, after determining the current acceptance value for each of the plurality of acceptance dimensions corresponding to the vehicle to be tested, to:
determine an updated mode of the vehicle to be tested according to the hierarchical relationship among the plurality of acceptance dimensions, the conversion weight values among the plurality of acceptance dimensions, and the current acceptance values for the plurality of the acceptance dimensions.

11. The apparatus according to claim 7, wherein the one or more processors are further configured, after determining the user acceptance of the vehicle to be tested, to:
determine an operation mode of the vehicle to be tested according to the user acceptance of the vehicle to be tested.

12. The apparatus according to claim 7, wherein the one or more processors are further configured, after determining the current acceptance value for each of the plurality of acceptance dimensions corresponding to the vehicle to be tested, to:
obtain a target operation environment corresponding to the vehicle to be tested; and
correct the current acceptance value for each of the plurality of acceptance dimensions corresponding to the vehicle to be tested according to a difference between the target operation environment and a current actual operation environment.

13. A non-transitory computer readable storage medium having a computer program stored thereon, wherein when the program is executed by a processor, the program implements a method for measuring user acceptance of an autonomous vehicle, comprising:
determining a feature for each of a plurality of functional dimensions of a vehicle to be tested according to configuration information of the vehicle to be tested;
determining a current acceptance value for each of a plurality of acceptance dimensions corresponding to the vehicle to be tested, according to a preset mapping relationship between the functional dimension and the acceptance dimension as well as the feature for the functional dimension of the vehicle to be tested; and
determining the user acceptance of the vehicle to be tested according to the current acceptance values for the plurality of the acceptance dimensions.

14. The non-transitory computer readable storage medium according to claim 13, before determining the current acceptance value for each of the plurality of acceptance dimensions corresponding to the vehicle to be tested, further comprising:
performing statistical analysis on data in a statistical data collection by using a structural equation model, to determine the preset mapping relationship between the functional dimension and the acceptance dimension.

15. The non-transitory computer readable storage medium according to claim 14, after performing the statistical analysis on the data in the statistical data collection by using the structural equation model, further comprising:
determining a hierarchical relationship among the plurality of acceptance dimensions and conversion weight values among the plurality of acceptance dimensions, and
determining the user acceptance of the vehicle to be tested according to the current acceptance values for the plurality of the acceptance dimensions comprises:
determining the user acceptance of the vehicle to be tested according to the hierarchical relationship among the plurality of acceptance dimensions, the conversion weight values among the plurality of acceptance dimensions, and the current acceptance values for the plurality of the acceptance dimensions.

16. The non-transitory computer readable storage medium according to claim 15, after determining the current acceptance value for each of the plurality of acceptance dimensions corresponding to the vehicle to be tested, further comprising:
determining an updated mode of the vehicle to be tested according to the hierarchical relationship among the plurality of acceptance dimensions, the conversion weight values among the plurality of acceptance dimensions, and the current acceptance values for the plurality of the acceptance dimensions.

17. The non-transitory computer readable storage medium according to claim 13, after determining the user acceptance of the vehicle to be tested, further comprising:
determining an operation mode of the vehicle to be tested according to the user acceptance of the vehicle to be tested.

18. The non-transitory computer readable storage medium according to claim 13, after determining the current acceptance value for each of the plurality of acceptance dimensions corresponding to the vehicle to be tested, further comprising:
obtaining a target operation environment corresponding to the vehicle to be tested; and
correcting the current acceptance value for each of the plurality of acceptance dimensions corresponding to the vehicle to be tested according to a difference between the target operation environment and a current actual operation environment.
